(19) United States
(12) Patent Application Publication
(10) Pub. No.: US 2007/0173146 A1
(43) Pub. Date: Jul. 26, 2007

(54) Rug dots

(76) Inventor: Regina Roberts-Swope, Nashville, TN (US)

Correspondence Address: REGINA ROBERTS-SWOPE, 5200 GRANNY WHITE PIKE, NASHVILLE, TN, 37220, US

(21) Appl. No.: 11/447,262

(22) Filed: Jul. 25, 2006

Related U.S. Application Data
(60) Provisional application No. 60/761,852, filed on Jan. 25, 2006.

(51) Int. Cl. D04H 1/00; B32B 27/12; B32B 27/02; D03D 15/00; B32B 27/04

(52) U.S. Cl. 442/2; 442/49; 442/43; 442/46

(57) ABSTRACT

RUG DOTS are unique in that they are manufactured in a circular dimension. While any consumer is familiar with a square or rectangular area pad, RUG DOTS eliminates the need to cut or otherwise modify a common square pad by presenting the finished circular design directly to the consumer. The consumer need only pick the proper size RUG DOT, place the RUG DOT on the floor, and place the rug or carpet over it; saving both time and money.

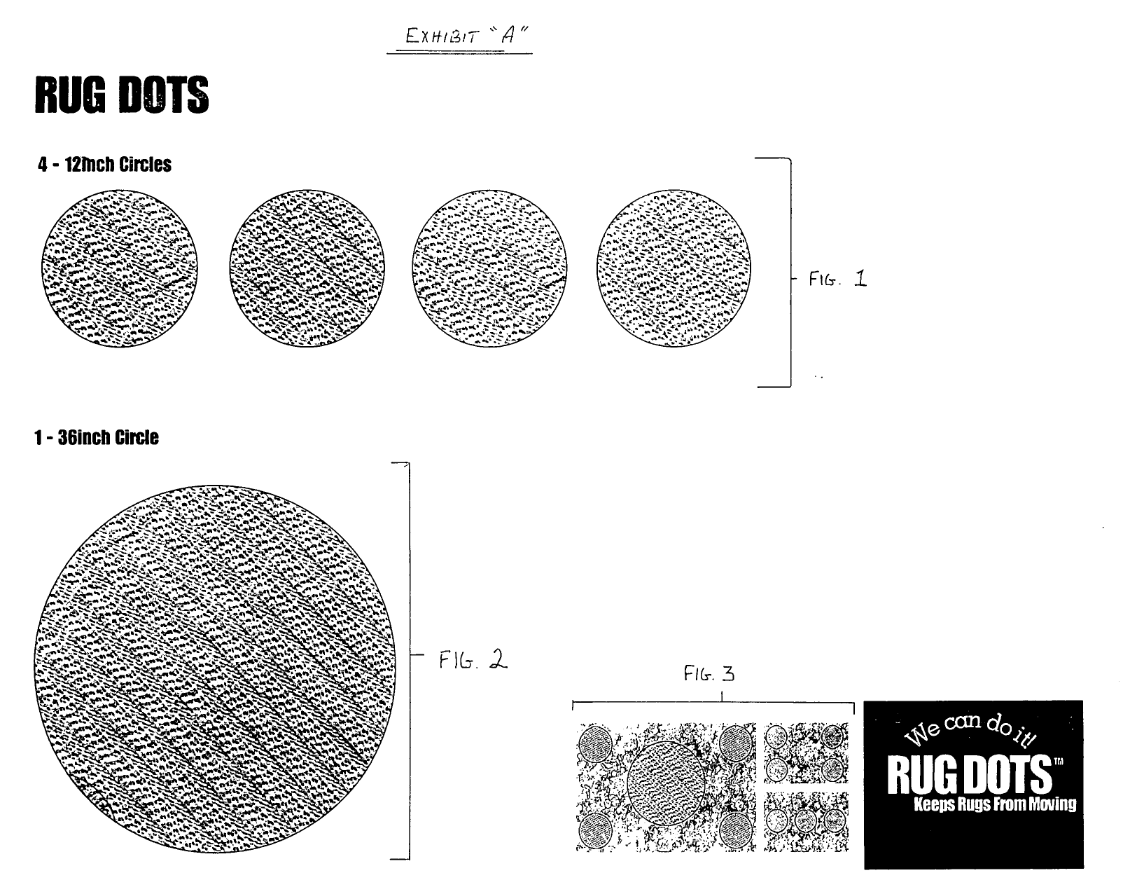

RUG DOTS are circular non slip pads used under rugs on any smooth surface flooring to prevent movement of the rug or carpet.

See “Exhibit A”: RUG DOTS are manufactured in various sizes ranging from twelve inches up to thirty six inches to accommodate any size rug, carpet or runner. RUG DOTS are one quarter inch thick, and custom cut to each particular packaged size specification.

RUG DOTS can be manufactured with a variety of substances including, but not limited to:
1) Woven Polyester Fabric (scrim) coated with PVC
2) 100% Natural Rubber
3) Polyester Fabric coated with adhesive
4) Latex with Polyester scrim latex compound
5) Woven Polyester Fabric coated with poly-vinyl compound
6) 100% Virgin Fiber Felt Cushion with Natural Rubber Backing
7) Needle Punch Fabric with waffle Duragon non slip rubber backing

1) RUG DOTS are area pads constructed to fulfill all needs and requirements for under any size rug laid upon hardwood, tile, ceramic, stone, vinyl, stone, or any other smooth flooring surface.

2) RUG DOTS keep rugs and carpets from traveling across flooring.

3) RUG DOTS are made of non-slip woven polyester fabric (scrim) with a PVC coating in circles ranging from twelve inches to thirty six inches in diameter.
